(19) United States
(12) Patent Application Publication
(10) Pub. No.: US 2016/0182814 A1
(43) Pub. Date: Jun. 23, 2016

(54) AUTOMATIC CAMERA ADJUSTMENT TO FOLLOW A TARGET

(71) Applicant: Microsoft Technology Licensing, LLC, Redmond, WA (US)

(72) Inventors: Mark Schwesinger, Bellevue, WA (US); Simon P. Stachniak, Redmond, WA (US); Tim Franklin, Seattle, WA (US)

(21) Appl. No.: 14/577,036

(22) Filed: Dec. 19, 2014

(51) Int. Cl. H04N 5/232; H04N 7/15; G06K 9/00; H04N 7/14

(52) U.S. Cl. CPC H04N 5/23216; H04N 7/142; H04N 7/15; H04N 5/23219; H04N 5/23296; H04N 5/23293; G06K 9/00255; G06K 9/00335

(57) ABSTRACT

An example computer-implemented method for following a target comprises receiving digital image information from a digital camera having an adjustable field of view of an environment, displaying via a display device a plurality of candidate targets that are followable within the environment, computer-recognizing user selection of a candidate target to be followed in the image environment, and machine-adjusting the field of view of the camera to follow the user-selected candidate target.

### BACKGROUND

Videoconferencing may allow one or more users located remotely from a location to participate in a conversation, meeting, or other event occurring at the location.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Embodiments for following a target with a camera are provided. One example computer-implemented method comprises receiving digital image information from a digital camera having an adjustable field of view of an environment, displaying via a display device a plurality of candidate targets that are followable within the environment, computer-recognizing user selection of a candidate target to be followed in the image environment, and machine-adjusting the field of view of the camera to follow the user-selected candidate target.

### BRIEF DESCRIPTION OF THE DRAWINGS

FIG. 1 shows an example image environment including a camera having an adjustable field of view.

FIG. 2 is a flow chart illustrating a method for adjusting a field of view of a camera to follow a user.

FIGS. 3A-3B are a timeline showing a plurality of representative screen shots that may be displayed on a display device.

FIG. 4 is a non-limiting example of a computing system.

### DETAILED DESCRIPTION

Videoconferencing or video chatting may allow users located in remote environments to interface via two or more display devices. In at least one of the environments, a camera may be present to capture images for presentation to other remotely-located display devices. Typical videoconferencing systems may include a camera that has a fixed field of view. However, such configurations may make it challenging to maintain a particular user within the field of view of the camera. For example, a person giving a presentation may move around the environment. Even if cameras are present that allow for adjustable fields of view, determining which user or users to follow may be difficult.

According to embodiments disclosed herein, a candidate target (such as a human subject) may be selected for following by a camera having an adjustable field of view of an environment. The candidate target may be selected based on explicit user input. Once a candidate target is selected, the selected target may be followed by the camera, even as the selected target moves about the environment. The camera may be controlled by a computing device configured to receive the user input selecting the candidate target. Further, the computing device may perform image analysis on the image information captured by the camera in order to identify and tag the selected user. In this way, if the selected target exits the environment and then subsequently re-enters the environment, the computing device may recognize the selected target and resume following the selected target.

The explicit user input selecting the candidate target may include voice commands issued by a user (e.g., “follow me” or “follow Tim”), gestures performed by a user (e.g., pointing to a candidate target), or other suitable input. In some examples, all followable candidate targets present in the environment imaged by the camera may be detected via computer analysis (e.g., based on object or facial recognition). The candidate targets may be displayed on a display device with a visual marker indicating each candidate target (such as highlighting), and a user may select one of the displayed candidate targets to be followed (via touch input to the display device, for example). The user entering the user input may be a user present in the environment imaged by the camera, or the user may be located remotely from the imaged environment.

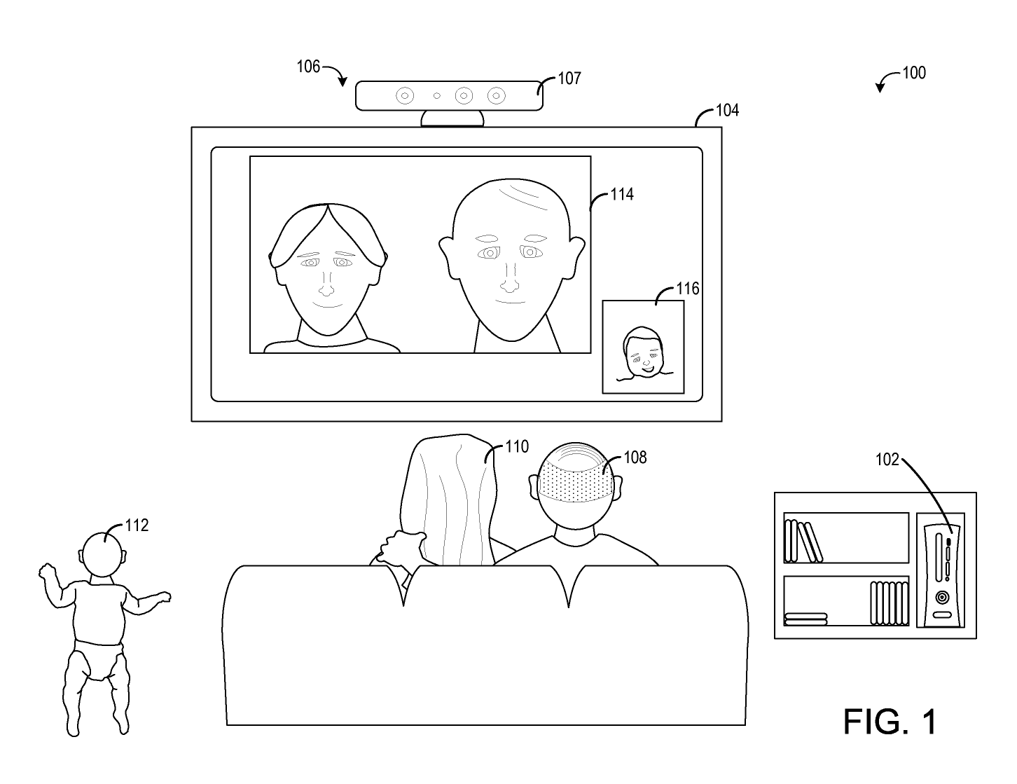

Turning now to FIG. 1, an example image environment 100 for videoconferencing is presented. Image environment 100 includes a computing device 102 operatively coupled to a display device 104 and a plurality of sensors 106 including at least a camera 107 having an adjustable field of view. The computing device may take the form of an entertainment console, personal computer, tablet, smartphone, laptop, server computing system, portable computing system, and/or any other suitable computing system.

Camera 107 is configured to capture image information for display via one or more display devices, such as display device 104 and/or other display devices located remotely from the image environment. Camera 107 may be a digital camera configured to capture digital image information, which may include visible light information, infrared information, depth information, or other suitable digital image information. Computing device 102 is configured to receive the image information captured by camera 107, render the image information for display, and send the image information to display device 104 and/or one or more additional display devices located remotely from image environment 100. Display device 104 is illustrated as a television or monitor device, however any other suitable display device may be configured to present the image information, such as integrated display devices on portable computing devices.

In the example illustrated in FIG. 1, image environment 100 includes three users, a father 108, mother 110, and toddler 112, participating in a videoconference session with two remote users (e.g., the grandparents of the toddler). Computing device 102 is configured to facilitate the videoconference with at least one remote computing system (not shown) by communicating with the remote computing system, via a suitable network, in order to send, and in some examples, receive image information.

During the videoconference session, image information of image environment 100 captured by camera 107 is optionally sent to display device 104 in addition to a display device of the remote computing system via computing device 102. As shown in FIG. 1, image information received from the remote computing system is displayed on display device 104 as main image 114. Further, in some examples, image information captured by camera 107 is also displayed on display device 104 as secondary image 116.

During the videoconference session, it may be desirable to maintain focus of the camera on a particular user, such as toddler 112. However, toddler 112 may crawl, toddle, walk, and/or run around the image environment 100. As will be described in more detail below, camera 107 may be machine-adjusted (e.g., adjusted automatically by computing device 102 without physical manipulation by a user) to follow a selected target within image environment 100. In the example illustrated in FIG. 1, the toddler 112 has been selected to be followed by camera 107. As such, camera 107 is automatically adjusted to follow toddler 112. This may include adjusting the field of view of camera 107 by adjusting the lens of camera 107 (e.g., panning, tilting, zooming, etc.) and/or by digitally cropping images captured by camera 107 such that toddler 112 is maintained in the image information sent to the remote computing system, even as the toddler 112 moves around the environment. Accordingly, as shown in FIG. 1, the image information captured by camera 107 and displayed in secondary image 116 includes toddler 112.

Toddler 112 may be selected to be the selected target followed by camera 107 based on explicit user input to computing device 102. For example, a user (such as the father 108 or mother 110) may issue a voice command indicating to the computing device 102 to follow toddler 112. The voice command may be detected by one or more microphones, which may be included in the plurality of sensors 106. Furthermore, the detected voice commands may be analyzed by a computer speech recognition engine configured to translate raw audio information into identified language. Such speech recognition may be performed locally by computing device 102, or the raw audio can be sent via a network to a remote speech recognizer. In some examples, the computer speech recognition engine may be previously trained via machine learning to translate audio information into recognized language.

In another example, a user may perform a gesture, such as pointing to toddler 112, to indicate to computing device 102 to follow toddler 112. User motion and/or posture may be detected by an image sensor, such as camera 107. Furthermore, the detected motion and/or posture may be analyzed by a computer gesture recognition engine configured to translate raw video (color, infrared, depth, etc.) information into identified gestures. Such gesture recognition may be performed locally by computing device 102, or the raw video can be sent via a network to a remote gesture recognizer. In some examples, the computer gesture recognition engine may be previously trained via machine learning to translate video information into recognized gestures.

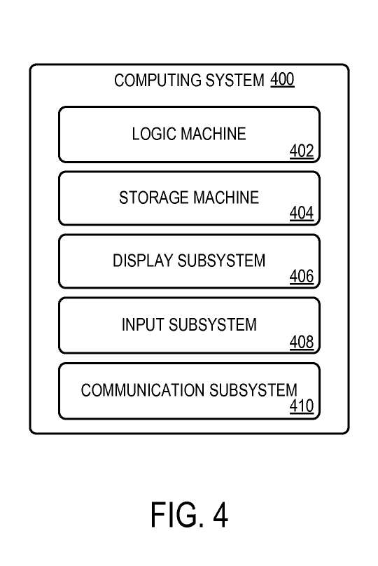

In a still further example, at least portions of the image information captured by camera 107 may be displayed on display device 104 and/or the remote display device during a target selection session, and a user may select a target to follow (e.g., via touch input to the display device, voice input, keyboard or mouse input, gesture input, or another suitable selection input). In such examples, computing device 102 may perform image analysis (e.g., object recognition, facial recognition, and/or other analysis) in order to determine which objects in the image environment are able to be followed, and these candidate targets may each be displayed with a visual marker indicating that they are capable of being followed. Additional detail regarding computing device 102 will be presented below with respect to FIG. 4.

The user selection of the target for the camera to follow may be performed locally or remotely. In the examples described above, a local user (e.g., the mother or father) performs a gesture, issues a voice command, or performs a touch input that is recognized by computing device 102. However, one or more remote users (e.g., the grandparents of the toddler) may additionally or alternatively enter input recognized by computing device 102 in order to select a target. This may include the remote user performing a gesture (imaged by a remote camera and recognized either remotely or by computing device 102), issuing a voice command (recognized remotely or locally by computing device 102), performing a touch input to a remote display device (in response to the plurality of candidate targets being displayed on the remote display device, for example), or other suitable input.

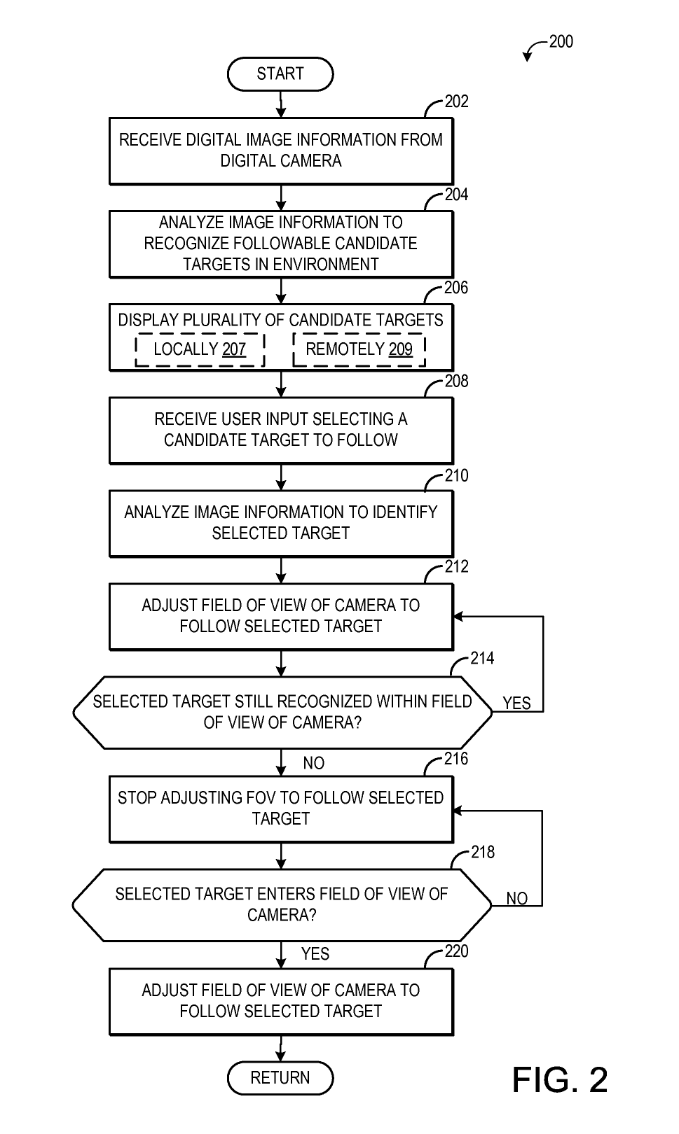

FIG. 2 is a flow chart illustrating a method 200 for following a target during a videoconference session. Method 200 may be performed by a computing device, such as computing device 102 of FIG. 1, in response to initiation of a videoconference session where image information captured by a camera operatively coupled to the computing device (such as camera 107) is displayed on one or more display devices, such as display device 104 of FIG. 1 and/or one or more remote display devices.

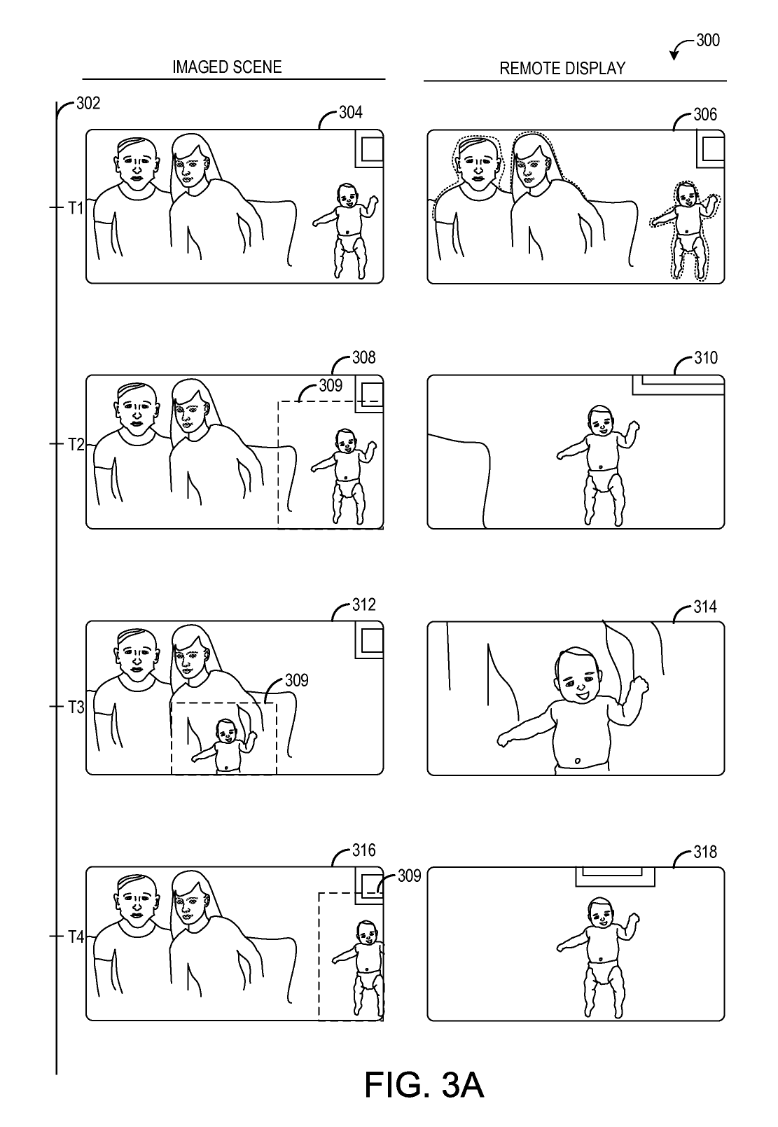

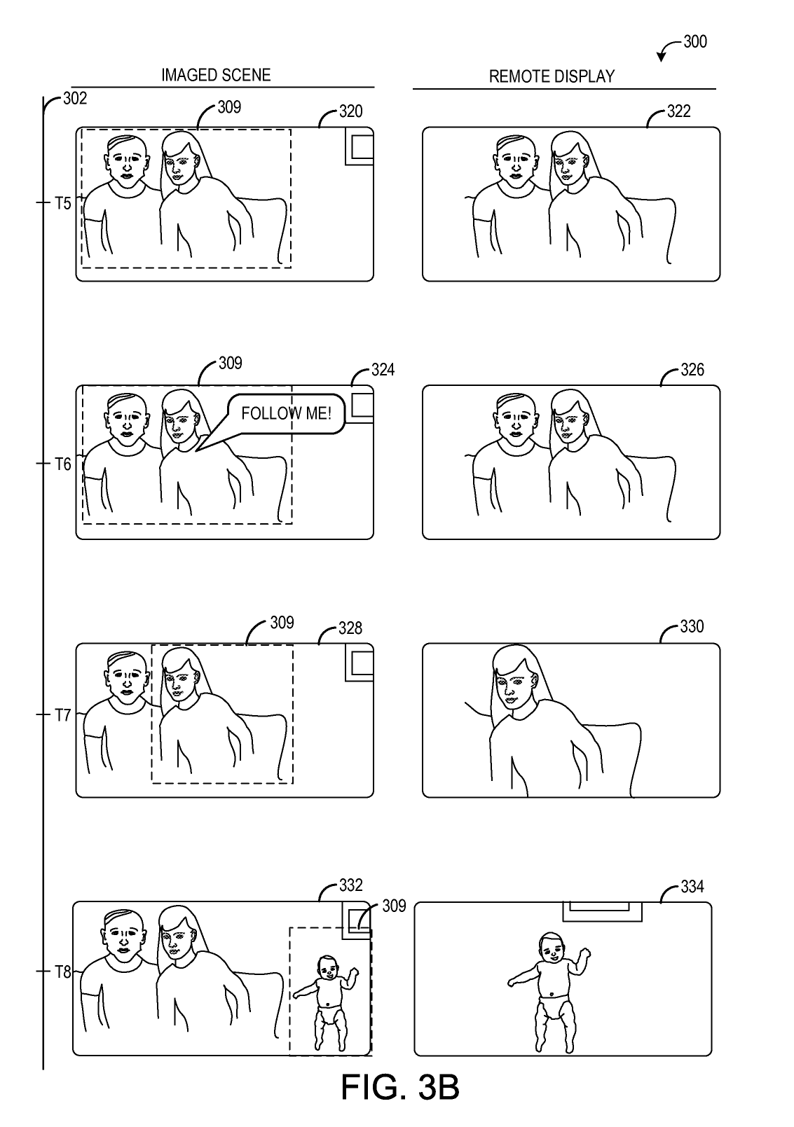

Method 200 will be described below with reference to FIGS. 3A-3B. FIGS. 3A-3B show a time plot 300 of representative events occurring in the imaged environment (shown by the images illustrated on the left of FIGS. 3A-3B) and corresponding screen shots captured by the camera (shown by the images illustrated on the right of FIGS. 3A-3B). The screen shots correspond to the images that may be displayed on a remote computing device (e.g., the grandparent's computing device). Timing of the events shown in FIG. 3 is represented by timeline 302.

At 202 of FIG. 2, method 200 includes receiving digital image information from a digital camera, such as camera 107 of FIG. 1. At 204, the digital image information may optionally be analyzed in order to recognize followable candidate targets in the environment imaged by the digital camera. For example, object recognition may be performed by the computing device to detect each object in the imaged environment. Detected objects that exhibit at least some motion may be determined to be followable candidate targets in some examples (e.g., human subjects, pets or other animals, etc.). In other examples, the object identification may include facial recognition or other analysis to differentiate human subjects in the environment from non-human subjects (e.g., inanimate objects), and the detected human subjects may be determined to be the followable candidate targets. In general, different computing systems may be programmed to follow different types of objects.

At 206, method 200 optionally includes displaying the plurality of candidate targets detected by the image analysis. The plurality of candidate targets may be displayed on a display device located in the same environment as the camera, as indicated at 207, on a remote display device located in a different environment as the camera, as indicated at 209, or both. The displayed candidate targets may be displayed along with visual markers indicating that the candidate targets are able to be followed, such as highlighting. In the case of person recognition (e.g., via facial recognition), tags may be used to name or otherwise identify recognized candidate targets.

For example, at time T1 of time plot 300 of FIG. 3A, the three users of FIG. 1 (the father, mother, and toddler) are present in the imagable environment, as shown by event 304. As used herein, imagable environment may include the entirety of the environment that the camera is capable of imaging. In some examples, the imagable environment may include the environment that can be imaged by more than one camera that cooperate to cover a field of view that exceeds the field of view of any one camera. The image analysis may determine that the three users are capable of being followed by the camera (e.g., the three users are the plurality of candidate targets). As shown by image 306, the three users are displayed on the display device or devices along with highlighting to indicate that the three users are capable of being followed.

Returning to FIG. 2, at 208, user input selecting a candidate target to follow is received. The user input may include a speech input detected by one or more microphones operatively coupled to the computing device, a gesture input detected by the camera and/or additional image sensor, a touch input to a touch-sensitive display (such as the display device in the imaged environment or the remote display device), or other suitable input. In some examples, when the plurality of candidate targets are displayed, the user input may include selection of one of the displayed candidate targets.

At 210, method 200 optionally includes analyzing the image information to identify the selected target. The image analysis may include performing facial recognition on the selected target in order to determine an identity of the selected target.

At 212, the field of view of the camera is adjusted to follow the selected target. Adjusting the field of view of the camera may include adjusting a lens of the camera to maintain focus on the selected target as the selected target moves about the imaged environment. For example, the camera may include one or more motors that are configured to change an aiming vector of the lens (e.g., pan, tilt, roll, x-translation, y-translation, z-translation). As another example, the camera may include an optical or digital zoom. In other examples, particularly when the camera is a stationary camera, adjusting the field of view of the camera may include digitally cropping an image or images captured by the camera to maintain focus on the selected target. By adjusting the field of view of the camera based on the selected target, the selected target may be set as the focal point of displayed image. The selected target may be maintained at a desired level of zoom that allows other users viewing the display device to visualize the selected target at sufficient detail while omitting non-desired features from the imaged environment.

In some examples, a user may select more than one target, or multiple users may each select a different target to follow. In such cases, all selected targets may be maintained in the field of view of the camera when possible. When only one target is selected, the computing device may opt to adjust the field of view of the camera to remove other targets present in the imagable environment, even if those other targets have been recognized by the computing device, to maintain clear focus on the selected target. However, in some examples, other targets in the imagable environment may be included in the field of view of the camera when the camera is focused on the selected target.

Adjusting the field of view to follow the selected target is illustrated at times T2, T3, and T4 of FIG. 3. For example, as shown at time T2, a user has selected the toddler to follow. During event 308, which may represent the entire possible field of view imagable by the camera, the toddler is standing to the right of the couch in the imaged environment. Because the toddler has been selected as the target to follow, the camera may be zoomed or otherwise adjusted to create a following field of view (FOV) 309 (illustrated as a dashed box overlaid on event 308), resulting in displayed image 310, so that the toddler is the focus of the displayed image 310.

At time T3, the toddler has moved to the left and is now standing in front of the mother, shown by event 312. The following FOV 309 of the camera is adjusted to follow the toddler, shown by displayed image 314. At time T4, the toddler moves back to the right, shown by event 316, and the following FOV 309 of the camera is adjusted to continue to follow the toddler, as shown by displayed image 318.

Returning to FIG. 2, at 214, method 200 determines if the selected target is still recognized in the field of view of the camera. Based on the physical configuration of the camera and imaged environment, the environment the camera is capable of imaging is limited, even after adjusting the field of view of the camera. Thus, in some examples the selected target may exit the field of view adjustment range of the camera and is no longer able to be followed by the camera. Alternatively or additionally, the selected target may turn away from the camera or otherwise become unrecognizable to the computing device. If the selected target is still recognized in the field of view of the camera, the method loops back to 212 to continue to follow the selected target.

If the selected target is not recognized by the computing device, for example if the selected target exits the field of view adjustment range of the camera, the selected target may no longer be imaged by the camera, and thus method 200 proceeds to 216 to stop adjusting the field of view of the camera to follow the selected target. When the selected target is no longer recognizable by the computing device, the camera may resume a default field of view in some examples. The default field of view may include a widest possible field of view, a field of view focused on a center of the imaged environment, or other field of view. In other examples, a user may select another candidate target in the environment to follow responsive to the initial selected target exiting the adjustment range of the camera. In further examples, the computing device may adjust the field of view based on motion and/or recognized faces, or begin following the last target that was followed before losing recognition of the selected target. In a still further example, once the selected target exits the adjustment range of the camera, following of the selected target may be performed by a different camera in the environment.

The selected target exiting the field of view adjustment range of the camera is shown by times T5-T7 of FIG. 3B. At time T5, the toddler has exited the imagable environment of the camera, shown by event 320. In response, the adjustment of the field of view of the camera to follow the toddler may stop. Instead, the following FOV 309 may be adjusted to a default view, such as the center of the imagable environment, shown by displayed image 322.

At time T6, the mother issues a voice command instructing the computing device to follow her, shown by event 324. While the voice command is issued, the field of view of the camera remains at the default view, shown by displayed image 326. Once the voice command is received and interpreted by the computing device at time T7, the following FOV 309 of the camera may be adjusted to follow the mother, as shown by displayed image 330, even though the mother has not changed position, as shown by event 328.

Returning to FIG. 2, at 218, method 200 includes determining if the selected target re-enters the field of view of the camera, or is otherwise re-recognized by the computing device. If the selected target does not re-enter the field of view, the method returns to 216 and does not adjust the field of view to follow the selected target. However, if the selected target does re-enter the field of view of the camera, the computing device may be able to recognize that the selected target is again able to be followed. This may include the computing device having previously determined the identity of the selected target, and then identifying that the target entering the field of view of the camera is the previously-selected identified target. The field of view of the camera may then be adjusted to follow the selected target, as indicated at 220. In some examples, once the selected target is not recognized by the computing device, other targets may enter into the field of view of the camera. Each target may be identified, and if the target is determined to be the previously selected target, following of the selected target may resume. However, if the target cannot be identified or is determined not to be the previously-selected target, then the field of view adjustment to follow the selected target may continue to be suspended.

As shown by event 332 and displayed image 334 of FIG. 3B, the toddler renters the field of view of the camera. The computing device may identify the toddler as the previously-selected target, and adjust the following FOV 309 of the camera to again follow the toddler. However, in some examples where a new candidate target is selected, the currently-selected target may continue to be followed rather than the previously-selected target. Further, in examples where multiple candidate targets are selected to be followed, the field of view of the camera may be adjusted to follow both targets. This may include maintaining a lower level of zoom (e.g., wider field of view) such that both targets are maintained in the field of view.

Thus, method 200 described above provides for a user participating in a videoconference session, for example, to explicitly indicate to a computing device which target from among a plurality of candidate targets to follow. Once a candidate target is selected to be followed, a camera may be adjusted so that the selected target is maintained in the field of view of the camera. The user entering the input to select the candidate target may be located in the same environment as the selected target, or the user may be located in a remote environment.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 4 schematically shows a non-limiting embodiment of a computing system 400 that can enact one or more of the methods and processes described above. Computing system 400 is shown in simplified form. Computing system 400 may take the form of one or more personal computers, server computers, tablet computers, home-entertainment computers, network computing devices, gaming devices, mobile computing devices, mobile communication devices (e.g., smart phone), and/or other computing devices. Computing device 102 and the remote computing system described above with respect to FIGS. 1-2 are non-limiting examples of computing system 400.

Computing system 400 includes a logic machine 402 and a storage machine 404. Computing system 400 may optionally include a display subsystem 406, input subsystem 408, communication subsystem 410, and/or other components not shown in FIG. 4.

Logic machine 402 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 404 includes one or more physical devices configured to hold instructions executable by the logic machine to implement the methods and processes described herein. When such methods and processes are implemented, the state of storage machine 404 may be transformed—e.g., to hold different data.

Storage machine 404 may include removable and/or built-in devices. Storage machine 404 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 404 may include volatile, nonvolatile, dynamic, static, read/write, read-only, random-access, sequential-access, location-addressable, file-addressable, and/or content-addressable devices.

It will be appreciated that storage machine 404 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 402 and storage machine 404 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 implemented to perform a particular function. In some cases, a module, program, or engine may be instantiated via logic machine 402 executing instructions held by storage machine 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 406 may be used to present a visual representation of data held by storage machine 404. This visual representation may take the form of a graphical user interface (GUI). As the herein described methods and processes change the data held by the storage machine, and thus transform the state of the storage machine, the state of display subsystem 406 may likewise be transformed to visually represent changes in the underlying data. Display subsystem 406 may include one or more display devices utilizing virtually any type of technology. Such display devices may be combined with logic machine 402 and/or storage machine 404 in a shared enclosure, or such display devices may be peripheral display devices. Display device 104 and the remote display device described above with respect to FIGS. 1-2 are non-limiting examples of display subsystem 406.

When included, input subsystem 408 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity. The plurality of sensors 106 described above with respect to FIG. 1 may be one non-limiting example of input subsystem 408.

When included, communication subsystem 410 may be configured to communicatively couple computing system 400 with one or more other computing devices. Communication subsystem 410 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 400 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and sub-combinations of the various processes, systems and configurations, and other features, functions, acts, and/or properties disclosed herein, as well as any and all equivalents thereof.

An example of a computer-implemented method comprises receiving digital image information from a digital camera having an adjustable field of view of an environment, displaying via a display device a plurality of candidate targets that are followable within the environment, computer-recognizing user selection of a candidate target to be followed in the image environment, and machine-adjusting the field of view of the camera to follow the user-selected candidate target. Computer-recognizing user-selection of a candidate target may comprise recognizing a user input from a local user. The computer-recognizing user-selection of a candidate target may additionally or alternatively comprise recognizing a user input from a remote user. The method may additionally or alternatively further comprise computer analyzing the image information to recognize the plurality of candidate targets within the environment. The displaying the plurality of candidate targets may additionally or alternatively comprise displaying an image of the environment with a plurality of highlighted candidate targets. The computer-recognizing user-selection of a candidate target may additionally or alternatively comprise recognizing a user touch input to the display device at one of the highlighted candidate targets. The displaying via a display device a plurality of candidate targets that are followable within the environment may additionally or alternatively comprise sending image information with the plurality of candidate targets to a remote display device via a network. The computer-recognizing user-selection of a candidate target may additionally or alternatively comprise computer-recognizing a voice command via one or more microphones. The computer-recognizing user-selection of a candidate target may additionally or alternatively comprise computer-recognizing a gesture performed by a user via the camera. The candidate target may additionally or alternatively be a first candidate target, and the method may additionally or alternatively further comprise recognizing user selection of a second candidate target to be followed in the image environment, and adjusting the field of view of the camera to follow both the first candidate target and the second candidate target. Any or all of the above-described examples may be combined in any suitable manner in various implementations.

Another example of a method for following a human subject, performed on a computing device, comprises receiving digital image information of an environment including one or more human subjects from a digital camera having an adjustable field of view of the environment, receiving user input selecting a human subject of the one or more human subjects, computer-analyzing the image information to identify the selected human subject, machine-adjusting the field of view of the camera to follow the selected human subject until the human subject exits a field of view adjustment range of the camera, and responsive to a human subject coming into the field of view of the camera, machine-adjusting the field of view of the camera to follow the human subject if the human subject is the identified human subject. The method may further comprise computer analyzing the image information to recognize the one or more human subjects within the environment, and displaying via a display device image information with the one or more human subjects. The computer analyzing the image information to recognize the one or more human subjects may additionally or alternatively comprise performing a face-recognition analysis on the image information. The receiving user input selecting a human subject of the one or more human subjects may additionally or alternatively comprise receiving a user touch input to the display device at one of the human subjects. The display device may additionally or alternatively be located remotely from the computing device and the digital camera. Receiving user input selecting a human subject of the one or more human subjects may additionally or alternatively comprise receiving a voice command via one or more microphones operatively coupled to the computing device. Receiving user input selecting a human subject of the one or more human subjects may additionally or alternatively comprise receiving video from a camera and recognizing a user gesture in the video. Any or all of the above-described examples may be combined in any suitable manner in various implementations.

Another example of a method performed on a computing device comprises receiving digital image information from a digital camera having an adjustable field of view of an environment, computer-recognizing user selection of a target to be followed in the environment, and machine-adjusting the field of view of the camera to follow the user-selected target. Machine-adjusting the field of view of the camera may include automatically moving a lens of the camera. Machine-adjusting the field of view of the camera may additionally or alternatively include digitally cropping an image from the camera. Any or all of the above-described examples may be combined in any suitable manner in various implementations.

1. A computer-implemented method, comprising:
receiving digital image information from a digital camera having an adjustable field of view of an environment;
computer-analyzing the image information to recognize a plurality of candidate targets that are followable within the environment;
displaying via a display device an image of the environment with each of the plurality of candidate targets visually indicated as followable within the environment;
computer-recognizing user selection of a candidate target to be followed in the image environment;
computer-adjusting the field of view of the camera to follow the user-selected candidate target; and
displaying via the display device video with the computer-adjusted field of view following the user-selected candidate target.

2. The method of claim 1, wherein computer-recognizing user-selection of a candidate target comprises recognizing a user input from a local user.

3. The method of claim 1, wherein computer-recognizing user-selection of a candidate target comprises recognizing a user input from a remote user.

4. (canceled)

5. The method of claim 1, wherein displaying the image of the environment with each of the plurality of candidate targets visually indicated as followable within the environment comprises displaying an image of the environment with a plurality of highlighted candidate targets.

6. The method of claim 5, wherein computer-recognizing user-selection of a candidate target comprises recognizing a user touch input to the display device at one of the highlighted candidate targets.

7. The method of claim 1, wherein displaying via a display device an image of the environment with each of the plurality of candidate targets visually indicated as followable within the environment comprises sending image information with the plurality of candidate targets to a remote display device via a network.

8. The method of claim 1, wherein computer-recognizing user-selection of a candidate target comprises one or more of computer-recognizing a voice command via one or more microphones and computer-recognizing a gesture performed by a user via the camera.

9. (canceled)

10. The method of claim 1, wherein the candidate target is a first candidate target, and further comprising:
recognizing user selection of a second candidate target to be followed in the image environment; and
adjusting the field of view of the camera to follow both the first candidate target and the second candidate target.

11. On a computing device, a method for following a human subject, comprising:
receiving digital image information of an environment including one or more human subjects from a digital camera having an adjustable field of view of the environment;
receiving user input selecting a human subject of the one or more human subjects;
computer-analyzing the image information to identify the selected human subject;
computer-adjusting the field of view of the camera to follow the selected human subject until the human subject exits a field of view adjustment range of the camera;
displaying via a display device video with the computer-adjusted field of view following the selected human subject;
responsive to a human subject coming into the field of view of the camera, computer-adjusting the field of view of the camera to follow the human subject if the human subject is the identified human subject.

12. The method of claim 11, further comprising computer analyzing the image information to recognize the one or more human subjects within the environment, and displaying via the display device image information with the one or more human subjects.

13. The method of claim 12, wherein computer analyzing the image information to recognize the one or more human subjects comprises performing a face-recognition analysis on the image information.

14. The method of claim 12, wherein receiving user input selecting a human subject of the one or more human subjects comprises receiving a user touch input to the display device at one of the human subjects.

15. The method of claim 14, wherein the display device is located remotely from the computing device and the digital camera.

16. The method of claim 11, wherein receiving user input selecting a human subject of the one or more human subjects comprises receiving a voice command via one or more microphones operatively coupled to the computing device.

17. The method of claim 11, wherein receiving user input selecting a human subject of the one or more human subjects comprises receiving video from a camera and recognizing a user gesture in the video.

18. On a computing device, a method, comprising:
receiving digital image information from a digital camera having an adjustable field of view of an environment;
computer-recognizing user selection of a target to be followed in the environment;
computer-adjusting the field of view of the camera to follow the user-selected target; and
displaying via a display device video with the computer-adjusted field of view following the user-selected target.

19. The method of claim 18, wherein computer-adjusting the field of view of the camera includes automatically moving a lens of the camera.

20. The method of claim 18, wherein computer-adjusting the field of view of the camera includes digitally cropping an image from the camera.

21. The method of claim 1, wherein displaying via a display device an image of the environment with each of the plurality of candidate targets visually indicated as followable within the environment comprises displaying an image of the environment with each of the plurality of candidate targets tagged with a respective identity determined based on the computer-analyzing of the image information.

22. The method of claim 11, further comprising responsive to the human subject exiting the field of view adjustment range of the camera, reverting to a default field of view of the camera.
